(19) United States
(12) Patent Application Publication
(10) Pub. No.: US 2008/0182125 A1
(43) Pub. Date: Jul. 31, 2008

(54) Cationic latex as a carrier for bioactive ingredients and its use in wallboard manufacture

(75) Inventors: Venkataram Krishnan, Cary, NC (US); Howard Wayne Swofford, Newton, NC (US)

Correspondence Address: CLIFF D. WESTON;MICROBAN PRODUCTS COMPANY, 1115 VANSTORY DRIVE, SUITE 125, HUNTERSVILLE, NC, 28078, US

(73) Assignee: Microban Products Company, Huntersville, NC (US)

(21) Appl. No.: 11/895,540

(22) Filed: Aug. 24, 2007

Related U.S. Application Data
(60) Provisional application No. 60/839,886, filed on Aug. 24, 2006.

(51) Int. Cl. B32B 19/00; D21H 17/00

(52) U.S. Cl. 428/688; 162/161

(57) ABSTRACT

Wallboard, and the gypsum and paper layers that are used to prepare wallboard, can include latex compositions comprising latex particles incorporating bioactive components. Methods for preparing the latex particles, and for forming both wallboard as well as gypsum and paper layers for use in wallboard, are also disclosed. The latex compositions disclosed herein can be prepared, for example, by the emulsion polymerization of the latex component monomers in the presence of one or more of the listed bioactive components.

### REFERENCE TO RELATED APPLICATION

This application claims priority to U.S. Ser. No. 60/839,886, filed on Aug. 24, 2006, the contents of which are hereby incorporated by reference.

### TECHNICAL FIELD OF THE INVENTION

This invention relates to the field of polymeric materials for use in wallboard manufacture, and wallboard that includes such polymeric materials.

### BACKGROUND OF THE INVENTION

The construction and building material arts have endured a long-felt need for wallboard exhibiting durable antimicrobial properties, and especially antifungal properties. There have been several attempts to prepare wallboard that has antimicrobial properties, principally by incorporating antimicrobial compounds in the gypsum or the paper layers that form conventional wallboard. The concentrations of antimicrobial compounds incorporated into these wallboards, gypsum layers and paper layers have been relatively low, and, accordingly, the protection has been relatively short-lived.

Another problem in the prior art has been the difficulty in achieving efficient incorporation of an antimicrobial compound into the paper that conventional forms the face materials or surfaces of wallboard. Some technical solutions have demonstrated satisfactory incorporation levels, but these techniques come at commercially unacceptable costs.

The ability to effectively and affordably deliver and durably retain an antimicrobial component on a wallboard and provide sustained performance has been a challenge. It would be advantageous to provide antimicrobial compositions that enhance the antimicrobial protection afforded to wallboard over a sustained period of time.

### BRIEF DESCRIPTION OF THE DRAWINGS

FIGS. 1-3 are bar graphs showing results of microbiological assays on wallboard paper samples treated with various latex compositions as described herein.

FIG. 4 is a graph showing the evaluation of the antimicrobial properties of various antimicrobial latexes, coated on Kraft paper, using ASTM G21.

FIG. 5 is a graph showing the results of a 30-III fungal test, based on making a 1″X1″ chip of the dried latex, inoculating the fungal species directly on to the sample, and then observing its growth after 7 days.

FIG. 6 is a graph showing the results of a second round of testing of coated paper samples, tested according to ASTM D-3273 over a period of 28 days. In this study, the fungal species were not directly inoculated on the surface, but rather, were maintained in the humidity chamber as spores that would then land on the surface of the coated paper.

FIG. 7 is a graph showing the evaluation of the antimicrobial properties of paper in which an antimicrobial latex was incorporated into the paper in a wet end process, as compared to coated paper, using ASTM D-3273.

### DETAILED DESCRIPTION OF THE PREFERRED EMBODIMENT(S)

The present disclosure describes new latex polymeric materials that incorporate bioactive components and that can be used to provide antimicrobial protection to wallboard, and can be present as a binder in the gypsum and/or paper layers present in conventional wallboard. This disclosure also provides new methods and processes that allow incorporating high concentrations of an active ingredient such as antifungal agents during the emulsion polymerization. In one aspect, for example, the disclosed process can be used to incorporate from about 0.01 percent to about 40 percent, based on the total monomer weight (“phm” or parts per hundred of monomer), of a substantially hydrophobic bioactive ingredient during the emulsion polymerization. While the bioactive ingredient can be introduced at any stage during the polymerization process including very early during the seed formation stage, in one aspect, the bioactive component or additive (bioadditive) can be added during the later stages of polymerization process, for example, when from about 30 percent to about 90 percent of the monomer has been fed into the polymerization reactor.

In one aspect, a bioactive cationic polymer latex comprises:
a) a latex polymer comprising the polymerization product of: i) at least one ethylenically unsaturated first monomer; and ii) at least one ethylenically unsaturated second monomer that is cationic or a precursor to a cation;
b) at least one bioactive component at least partially encapsulated within the latex polymer, selected independently from triclosan, propiconazole, tebuconazole, zinc pyrithione, sodium pyrithione, triclocarban, diiodomethyl-4-tolylsulfone, thiabendazole, 3-iodo-2-propynyl butylcarbamate, tolyl diiodomethyl sulfone, or any combination thereof; and
c) optionally, at least one sterically bulky component incorporated into the latex polymer.

As provided herein, the at least one sterically bulky component incorporated into the latex polymer can be selected independently from at least one sterically bulky ethylenically unsaturated third monomer, at least one sterically bulky polymer, or any combination thereof. Each of these components, as well as optional or additional components, is considered herein.

In another aspect, a method for making a bioactive cationic polymer latex comprising initiating an emulsion polymerization of an aqueous composition comprises, at any time during the emulsion polymerization:
a) at least one ethylenically unsaturated first monomer;
b) at least one ethylenically unsaturated second monomer that is cationic or a precursor to a cation;
c) at least one bioactive component selected independently from triclosan, propiconazole, tebuconazole, zinc pyrithione, sodium pyrithione, triclocarban, diiodomethyl-4-tolylsulfone, thiabendazole, 3-iodo-2-propynyl butylcarbamate, tolyl diiodomethyl sulfone, or any combination thereof;
d) at least one free-radical initiator;
e) optionally, at least one sterically bulky ethylenically unsaturated third monomer;
f) optionally, at least one sterically bulky polymer; and
g) optionally, at least one non nonionic surfactant.

In yet another aspect, a method for making a bioactive cationic polymer latex comprises:
a) providing an aqueous composition comprising:
i) at least one ethylenically unsaturated first monomer;
ii) at least one ethylenically unsaturated second monomer that is cationic or a precursor to a cation;
iii) optionally, at least one sterically bulky ethylenically unsaturated third monomer;
iv) at least one free-radical initiator; and
v) optionally, at least one non-ionic surfactant;
b) initiating an emulsion polymerization of the composition; and
c) adding at least one bioactive component to the composition during the emulsion polymerization process;
wherein the at least one bioactive component is selected independently from triclosan, propiconazole, tebuconazole, zinc pyrithione, sodium pyrithione, triclocarban, diiodomethyl-4-tolylsulfone, thiabendazole, 3-iodo-2-propynyl butylcarbamate, tolyl diiodomethyl sulfone, or any combination thereof.

Many compounds and species that can be used as ethylenically unsaturated first monomers, ethylenically unsaturated second monomers, and sterically bulky components are disclosed in the European Patent Number EP 1109845 and the corresponding PCT Published Patent Application WO 00/8008077.

### Ethylenically Unsaturated First Monomers

Various ethylenically unsaturated first monomers can be used in the latex of the present disclosure. In one aspect, ethylenically unsaturated first monomers can be non-cationic. Examples of suitable monomers can be found at least in U.S. Pat. No. 5,830,934, U.S. Patent Application Publication Numbers 2005/0065284 and 2005/0003163, and European Patent Number EP 1109845, all to Krishnan. In this aspect, examples of such monomers include, but are not limited to, vinyl aromatic monomers, halogenated or non-halogenated olefin monomers, aliphatic conjugated diene monomers, non-aromatic unsaturated mono- or dicarboxylic ester monomers, monomers based on the half ester of an unsaturated dicarboxylic acid monomers, unsaturated mono- or dicarboxylic acid monomers, nitrogen-containing monomers, nitrile-containing monomers, cyclic or acyclic amine-containing monomer, branched or unbranched alkyl vinyl ester monomers, halogenated or non-halogenated alkyl acrylate monomers, halogenated or non-halogenated aryl acrylate monomers, carboxylic acid vinyl esters, acetic acid alkenyl esters, carboxylic acid alkenyl esters, a vinyl halide, a vinylidene halide, or any combination thereof, any of which having up to 20 carbon atoms. In this aspect, this disclosure contemplates acrylate and methacrylate moieties when either moiety is disclosed in a suitable monomer. Thus, the disclosure that an acrylate monomer is a suitable ethylenically unsaturated first monomer also encompasses the disclosure that the corresponding methacrylate monomer is also a suitable first monomer. The abbreviation (meth)acrylate can be used to represent such a disclosure.

Many different ethylenically unsaturated first monomers can be used in preparing the bioactive lattices disclosed herein. In one aspect, suitable examples of ethylenically unsaturated first monomers include, but are not limited to, styrene, para-methyl styrene, chloromethyl styrene, vinyl toluene, ethylene, butadiene, methyl (meth)acrylate, ethyl (meth)acrylate, propyl (meth)acrylate, butyl (meth)acrylate, pentyl (meth)acrylate, glycidyl (meth)acrylate, isodecyl (meth)acrylate, lauryl (meth)acrylate, monomethyl maleate, itaconic acid, (meth)acrylonitrile, (meth)acrylamide, N-methylol (meth)acrylamide, N-(isobutoxymethyl)(meth)acrylamide, vinyl neodecanoate, vinyl versatates, vinyl acetate, C₃-C₈ alkyl vinylethers, C₃-C₈ alkoxy vinyl ethers, vinyl chloride, vinylidene chloride, vinyl fluoride, vinylidene fluoride, trifluoroethylene, tetrafluoroethylene, chlorotrifluoroethylene, hexafluoropropylene, chlorotrifluoroethylene, perfluorobutyl ethylene, perfluorinated C₃-C₈ alpha-olefins, fluorinated C₃-C₈ alkyl vinylethers, perfluorinated C₃-C₈ alkyl vinylethers, perfluorinated C₃-C₈ alkoxy vinyl ethers, and the like, or any combination thereof. Thus, halogenated analogs of suitable ethylenically unsaturated first monomers are encompassed by this disclosure, and it is intended that this disclosure encompass any and all suitable halogen-substituted analogs or derivatives of these monomers, including fluorine-substituted analogs, chlorine-substituted analogs, bromine-substituted analogs, and iodine-substituted analogs. The term “halogen-substituted” is meant to include partially halogen substituted and perhalogen substituted, in which any halogen substituents can be the same or can be different. In this aspect as well, it is intended herein to disclose both acrylate and methacrylate moieties when either moiety is disclosed in a suitable monomer.

In another aspect, the ethylenically unsaturated first monomer can be halogenated or can be non-halogenated. Similarly, the ethylenically unsaturated first monomer can be fluorinated or can be non-fluorinated. For example, fluorinated analogs of alkyl acrylates or methacrylates can be used, as well as the non-fluorinated compounds. The ethylenically unsaturated first monomer can also be chlorinated or can be non-chlorinated. The ethylenically unsaturated first monomer can also be brominated or can be non-brominated. The ethylenically unsaturated first monomer can also be iodinated or can be non-iodinated. For example, fluorinated analogs of alkyl acrylates or methacrylates can be used, as well as the non-fluorinated compounds.

In yet another aspect, the lattices provided herein can comprise from about 20 percent to about 99.5 percent by weight of the ethylenically unsaturated first monomer, based on the total monomer weight. In this aspect, the latex of the latex composition can also comprise from about 30 percent to about 99 percent, from about 40 percent to about 97 percent, from about 50 percent to about 95 percent, from about 60 percent to about 90 percent, or from about 70 percent to about 90 percent by weight of the ethylenically unsaturated first monomer, based on the total monomer weight. In this aspect, the intent herein is to disclose individually each possible number that such ranges could reasonably encompass, as well as any sub-ranges and combinations of sub-ranges encompassed therein. In this aspect, as understood by the skilled artisan, the particular chemical and physical properties of a specific monomer will have a bearing on the range of weight percentages most suitable for that monomer.

### Ethylenically Unsaturated Cationic Second Monomers

In still another aspect, the latex polymer of the present disclosure also comprises the polymerization product of at least one ethylenically unsaturated second monomer that is cationic or a precursor to a cation. As provided herein, the at least one ethylenically unsaturated second monomer that is cationic or a precursor to a cation can be collectively referred to by the term “cationic monomer,” that is, any monomer which possesses or can be made to posses a positive charge. In one aspect, this positive charge may be imparted by the presence of a heteroatom in the monomer, such as nitrogen, that can constitute the site of attachment of a proton or any other cationic Lewis Acid that would impart a positive charge to the monomer. For example, quaternary amine monomers can be used as a “cationic monomer” in the latex of the disclosure, which includes quaternary amine monomers obtained from any neutral amine monomer disclosed herein by, for example, protonation using an acid or by alkylation using an alkyl halide. Exemplary heteroatoms include, but are not limited to, nitrogen, sulfur, phosphorus, and the like. Thus, the cationic monomer is typically incorporated into the latex polymer by virtue of its ethylenic unsaturation.

Examples of suitable cationic monomers can be found at least in U.S. Patent Application Publication Numbers 2005/0065284 and 2005/0003163, to Krishnan. In this aspect, examples of cationic monomers include, but are not limited to, an amine monomer, an amide monomer, a quaternary amine monomer, a phosphonium monomer, a sulfonium monomer, or any combination thereof, any of which having up to 20 carbon atoms. Further, suitable examples of ethylenically unsaturated cationic monomers that can be used in the latex of the present disclosure include, but are not limited to, dimethylaminoethyl acrylate; diethylaminoethyl acrylate; dimethyl aminoethyl methacrylate; diethylaminoethyl methacrylate; tertiary butylaminoethyl methacrylate; N,N-dimethyl acrylamide; N,N-dimethylaminopropyl acrylamide; acryloyl morpholine; N-isopropyl acrylamide; N,N-diethyl acrylamide; dimethyl aminoethyl vinyl ether; 2-methyl-1-vinyl imidazole; N,N-dimethyl-aminopropyl methacrylamide; vinyl pyridine; vinyl benzyl amine; dimethylaminoethyl acrylate, methyl chloride quaternary; dimethylaminoethyl methacrylate, methyl chloride quaternary; diallyldimethylammonium chloride; N,N-dimethylaminopropyl acrylamide, methyl chloride quaternary; trimethyl-(vinyloxyethyl)ammonium chloride; 1-vinyl-2,3-dimethylimidazolinium chloride; vinyl benzyl amine hydrochloride; vinyl pyridinium hydrochloride; or any combination thereof. While these listed examples include both free base compounds, and various quaternary salts such as hydrochloride or methyl chloride quaternary salts, any suitable Lewis acid that imparts a positive charge to the monomer can be used to form the cationic monomers of this disclosure.

In a further aspect, other amines or amine salts can also be used as ethylenically unsaturated second monomers to prepare the latex polymer of the present disclosure. For example, various amine salts can be obtained, for example, by the reaction of an epoxy group with a secondary amine and the subsequent neutralization of the newly formed tertiary amine with an acid. For example, the reaction of glycidyl methacrylate with a secondary amine can be carried out and the product can be free radically polymerized. Quaternary amine functionality can also be generated as a “post-reaction” on a preformed polymer having, for example, an epoxy group. Examples of such reactions are described in the article, “Polymer Compositions for Cationic Electrodepositable Coatings,” Journal of Coatings Technology, Vol. 54, No 686, March 1982. It should also be appreciated that cationic functionality can also be imparted using sulfonium or phosphonium chemistry, examples of which are described in this reference, as will be appreciated by one of ordinary skill in art.

In a further aspect, the latex polymer of this disclosure can comprise from about 0.01 to about 75 percent by weight of the ethylenically unsaturated second monomer that is cationic or a precursor to a cation, based on the total monomer weight. In this aspect, the latex can also comprise from about 0.025 to about 70 percent, from about 0.05 to about 60 percent, from about 0.1 to about 50 percent, from about 0.25 to about 40 percent, from about 0.5 to about 30 percent, from about 1 to about 20 percent, or from about 1.5 to about 15 percent, by weight of the cationic second monomer, based on the total monomer weight. In this aspect, the intent is to disclose individually each possible number that such ranges could reasonably encompass, as well as any sub-ranges and combinations of sub-ranges encompassed therein.

### Sterically Bulky Components

As disclosed herein, a bioactive polymer latex composition as disclosed herein can comprise: a) a latex polymer as disclosed herein; b) at least one bioactive component at least partially encapsulated within the latex polymer; and c) optionally, at least one sterically bulky component incorporated into the latex polymer. The at least one sterically bulky component incorporated into the latex polymer can be selected independently from at least one sterically bulky ethylenically unsaturated third monomer, at least one sterically bulky polymer, or any combination thereof. In this aspect, and while not intending to be bound by theory, this sterically bulky component is typically incorporated into the cationic polymer latex to sterically stabilize the latex.

As used herein, the term “incorporated” with respect to the use of the at least one sterically bulky ethylenically unsaturated third monomer includes, but is not limited to, the attachment of this third monomer to the cationic polymer, for example, by co-polymerization of the third monomer with the first monomer and second cationic monomer disclosed herein, to form the cationic polymer latex. Further, the term “incorporated” with respect to the at least one sterically bulky ethylenically unsaturated third monomer can also include the attachment of this third monomer to the cationic polymer in any other fashion, such as, for example, by grafting onto the polymer backbone. In another aspect, the term “incorporated” with respect to the use of the at least one sterically bulky polymer includes, but is not limited to, the attachment or association of this polymer into the latex for methods including, but not limited to, adsorbing or grafting the sterically bulky polymer onto the latex surface. For example, polyvinyl alcohol can be incorporated into the latex in this manner. This sterically stabilizing component can encompass a nonionic monomer or nonionic polymer which incorporate steric stabilization to the latex particle without affecting the deposition characteristics of the cationic polymer latex.

Exemplary monomers that can be used as sterically bulky ethylenically unsaturated third monomers include, but are not limited to, those ethylenically unsaturated monomers that contain alkoxylated (for example, ethoxylated or propoxylated) functionalities. In one aspect, examples of such monomers include, but are not limited to, at least one a sterically bulky ethylenically unsaturated compound selected independently from the following:
a) CH₂═C(R^{1A})COO(CH₂CHR^{2A}O)ₘR^{3A}, wherein R^{1A}, R^{2A}, and R^{3A} can be selected independently from H or an alkyl group having from 1 to 6 carbon atoms, inclusive, and m can be an integer from 1 to 30, inclusive. In this aspect, R^{1A}, R^{2A}, and R^{3A} can also be selected independently from H or methyl, m can be an integer from 1 to 10, inclusive;
b) CH₂═C(R^{1B})COO(CH₂CH₂O)ₙ(CH₂CHR^{2B}O)ₚR^{3B}, wherein R^{1B}, R^{2B}, and R^{3B} can be selected independently from H or an alkyl group having from 1 to 6 carbon atoms, inclusive, and n and p can be integers selected independently from 1 to 15, inclusive. Also in this aspect, R^{1B}, R^{2B}, and R^{3B} can be selected independently from H or methyl, and n and p can be integers selected independently from 1 to 10, inclusive;
c) CH₂═C(R^{1C})COO(CH₂CHR^{2C}O)_{q}(CH₂CH₂O)ᵣR^{3C}, wherein R^{1C}, R^{2C}, and R^{3C} can be selected independently from H or an alkyl group having from 1 to 6 carbon atoms, inclusive, and q and r can be integers selected independently from 1 to 15, inclusive. Further to this aspect, R^{1C}, R^{2C}, and R^{3C} can be selected independently from H or methyl, and q and r can be integers selected independently from 1 to 10, inclusive; or
d) any combination of any of these compounds.

In another aspect, a number of other types of unsaturated compounds can be used as sterically bulky ethylenically unsaturated third monomers include, but are not limited to, polymerizable surfactants. Thus, further examples of suitable sterically bulky ethylenically unsaturated third monomers include, but are not limited to, alkoxylated monoesters of a dicarboxylic acid; alkoxylated diesters of a dicarboxylic acid; polyoxyethylene alkylphenyl ethers such as NOIGEN RN™; or any combination thereof. In this aspect, for example, ethoxylated mono- and diesters of diacids such as maleic and itaconic acids can also be used to achieve the desired stabilizing effect. Acrylate, methacrylate, vinyl and allyl analogs of surfactants, referred to as polymerizable surfactants, can also be used in this manner. Examples of such polymerizable surfactants include, but are not limited to, TREM LF-40™ sold by Cognis. In one aspect, these surfactants are typical in that they possess ethylenic unsaturation that allows the surfactants to be incorporated into the latex polymer itself, as well as possessing hydrophobic and hydrophilic functionality that varies. In another aspect, surfactants that are particularly applicable to the present composition include the nonionic surfactants, wherein the hydrophilic character is believed to be attributable to the presence of alkylene oxide groups. Examples of suitable nonionic surfactants include, but are not limited to, ethylene oxide, propylene oxide, butylene oxide, and the like. In such species, the degree of hydrophilicity can vary based on the selection of functionality.

The at least one sterically bulky component incorporated into the latex polymer can also constitute at least one polymer. Again, while not intending to be bound by theory, it is thought that such polymers provide steric stability to the resulting latex polymer. Such polymers are sometimes referred to in the art as protective colloids. Examples of sterically bulky polymers include, but are not limited to, polyvinyl alcohols, polyvinyl pyrollidone, hydroxyethyl cellulose, and the like, including any combination of these materials. Moreover, mixtures or combinations of any of the aforementioned sterically bulky monomers and any of these sterically bulky polymers can also be used as the at least one sterically bulky component that is incorporated into the latex polymer. A number of other monomers and polymers that can be used in the present latex composition that can impart stability are provided in U.S. Pat. No. 5,830,934 to Krishnan et al.

The optional at least one sterically bulky component can be present in an amount ranging from 0 to about 25 percent by weight, based on the total weight of the monomers. In this aspect, the latex of this disclosure can also comprise from about 0.1 to about 20 percent, from about 0.2 to about 18 percent, from about 0.5 to about 15 percent, from about 0.7 to about 12 percent, or from about 1 to about 10 percent by weight of the sterically bulky component, based on the total monomer weight. In this aspect, the intent is to disclose individually each possible number that such ranges could reasonably encompass, as well as any sub-ranges and combinations of sub-ranges encompassed therein.

### Free Radical Initiators

In still a further aspect, the latex of the present disclosure can include a free radical initiator, the selection of which is known to one of ordinary skill in the art. Thus, while any polymerization initiator whether it is cationic or anionic in nature can be used as a polymerization initiator, for example, persulfates, peroxides, and the like, typical initiators are azo-based compounds and compositions. Moreover, in this aspect, for producing a cationic latex, any free radical initiator which generates a cationic species upon decomposition and contributes to the cationic charge of the latex can be utilized. In this aspect, the typical initiators also include azo-based compounds and compositions. Examples of such an initiator include, but are not limited to, is 2,2′-azobis(2-amidinopropane)dihydrochloride), which is sold commercially as WAKO V-50™ by Wako Chemicals of Richmond, Va.

### Bioactive/Antimicrobial Agents and Their Incorporation

The antimicrobial agents are specifically selected for their use in wallboard, and are selected from triclosan, propiconazole, tebuconazole, zinc pyrithione, sodium pyrithione, triclocarban, diiodomethyl-4-tolylsulfone, thiabendazole, 3-iodo-2-propynyl butylcarbamate, and combinations or mixtures thereof. For example, one suitable antimicrobial agent is propiconazole which is commercially available from Janssen Pharmacetica under the trade name WOCOSEN™. Another antimicrobial agent suitable for use in this composition is diiodomethyl-4-tolylsulfone which is also commercially available from Dow Chemical under the trade name AMICAL™. When zinc pyrithione is used, small amounts of a solvent such as N-methyl pyrrolidone can be used to better solubilize the zinc pyrithione before it is added to the reactor. In one aspect, the useful antifungal additives include propiconazole and tebuconazole. Examples of suitable antimicrobial agents that are applicable for use in wallboard are provided in U.S. Pat. No. 6,767,647, which is incorporated herein by reference in its entirety.

At least one first antimicrobial agent as described above optionally can be used in combination with at least one second antimicrobial agent as described above, and optionally in combination with at least one third antimicrobial agent as described above, to constitute the bioactive component as disclosed herein. Combinations of antimicrobial agents may be useful in providing particular properties to the resulting bioactive cationic polymer latex. For example, the at least one first antimicrobial agent can be selected from propiconazole, sodium pyrithione, or mixtures thereof, and the at least one second antimicrobial agent can be selected from tolyl diiodomethyl sulfone, tebuconazole, thiabendazole, 3-iodo-2-propynyl butylcarbamate, or any combination thereof. As understood by the skilled artisan, the relative amounts and concentrations of each antimicrobial agent can be adjusted to achieve the desired levels of efficacy, with higher concentrations typically leading to higher activity.

Cationic latex has proved very useful due, in part, to the inherent antimicrobial attributes of the cationic polymer which can be supplemented with at least one of the listed antimicrobial agents. In this aspect, methods are disclosed for preparing an antifungal fortified cationic latex and to deposit such a latex through a wet end process onto pulp fibers, such that the resultant sheet of paper is substantially antifungal. This method, which includes deposition onto pulp fibers, highlights the utility of this process that incorporates an antimicrobial active ingredient into a resulting cationic latex for deposition, in part, because the process is facilitated by opposite charges on the pulp fibers and the cationic latex. This opposite charge feature typically leads to substantial uniformity of deposition of the cationic latex on the fiber and a substantially homogeneous product.

As provided herein, a wide range of polymerization conditions can be used. In one aspect, the bioactive component or additive is typically soluble in at least one of the monomers employed, and/or soluble in a monomer mixture or composition used. In another aspect, the bioactive additive can be introduced at any stage during the polymerization process including very early during the seed formation stage, including initiating the emulsion polymerization when all the components of the composition, including the at least one bioactive component, are present at the time of initiation. In another aspect, the bioadditive can be added during a later stage of polymerization process. For example, the bioactive ingredient can be introduced into the monomer feed when about 30 percent of the monomer has been fed into the polymerization reactor.

While not intending to be bound by theory, it is believed that introducing the bioactive component into the monomer feed relatively late in the polymerization process could help minimize degradation of the bioactive agent arising from the polymerization conditions. For example, it is possible that the bioactive agent could be degraded at the temperature under which polymerization is conducted, or could react with certain monomers or other components. Accordingly, to minimize any such degradation process, the bioactive agent can be added at such a time in the process, for example, when the process is more than about 50%, more than about 60%, more than about 70%, more than about 80%, or more than about 90% complete, thus minimizing the contact time between the bioactive agent and other components under the polymerization conditions. Another approach to minimize degradation of the bioactive agent is to employ bioactive agents that comprise “latent” bioactive moieties that can be activated by thermal, chemical, photochemical, or similar means, at a suitable time after the emulsion polymerization.

In another aspect, the bioactive additive can be introduced at any stage during an emulsion polymerization process, including, for example at such a time during the process at which the resulting antimicrobial latex exhibits a bioactivity that is not substantially diminished relative to a standard bioactivity exhibited by the same antimicrobial latex prepared by adding the bioactive component when the emulsion polymerization is about 50% complete. Thus, this standard bioactivity is the activity of the same antimicrobial latex synthesized from the same bioactive component and the same latex at substantially the same concentrations, prepared by adding the bioactive component when the emulsion polymerization is about 50% complete, as evaluated under similar conditions. The term “not substantially diminished” is used to refer to any difference in activity of the resulting bioactive latex, relative to this standard bioactivity, that meets any one, or more than one, of the following criteria: 1) the measured activity of the resulting bioactive latex is less than or equal to about 15% lower than the measured activity of the standard; 2) the activity of the resulting bioactive latex has a numerical activity rating based on an arbitrary activity scale that is less than or equal to about 35% lower than the numerical activity rating of the standard; or 3) the empirically-based descriptive rating of the activity level of the resulting bioactive latex is no more than two descriptive rating levels lower than the activity rating level of the standard. The measurement of antimicrobial activity can be determined according to any one, or more than one, of the following test standards: ASTM E2180-01; ASTM E2149-01; ASTM E1882-05; ASTM D3273; AATCC Test Method 30, Part 3; AATCC Test Method 100; ASTM D5590. An example of criterion 1) of “not substantially diminished” is as follows. A bioactive additive can be introduced at a time, or introduction can be initiated at a time, during an emulsion polymerization process so as to provide a resulting antimicrobial latex having a minimum inhibitory concentration (MIC) of 0.009 mg/mL, which is less than 15% lower than a MIC of 0.010 mg/mL for the standard. An example of criterion 2) of “not substantially diminished” is as follows. The bioactive additive can be introduced at a time, or introduction can be initiated at a time, during an emulsion polymerization process so as to provide a resulting antimicrobial latex having numerical activity rating of bioactivity based on an arbitrary activity scale of 5, which is less than 35% lower than the numerical activity rating of bioactivity of 7 for the standard. An example of criterion 3) of “not substantially diminished” is as follows. In an empirically-based descriptive rating system that includes contiguous rating levels of “excellent activity,” “very good activity,” and “good activity,” the bioactive additive can be introduced at a time, or introduction can be initiated at a time, during an emulsion polymerization process so as to provide a resulting antimicrobial latex having an activity rating of “good activity,” as compared to an activity rating of “excellent activity” for the standard. In any of these measurements of activity, the bioactive additive can be introduced at any time during the polymerization process that provides this result, or introduction can be initiated at a time during the polymerization process that provides the result disclosed above.

In another aspect, it is not necessary to introduce the bioactive component into the monomer feed relatively late in the polymerization process. For example, the bioadditive agent can also be added when about 0 percent, about 10 percent, about 20 percent, about 30 percent, about 40 percent, about 50 percent, about 60 percent, about 70 percent, about 80 percent, about 90 percent, or about 100 percent of the monomer has been fed into the polymerization reactor. In this aspect, the emulsion polymerization is initiated at a time when all components of the composition are not present from the time of initiation, but some are added at various times after initiating the polymerization, including, but not limited to, the at least one bioactive component. Also in this aspect, the intent is to disclose any and all ranges between such numbers, and to claim individually each possible number that such ranges could reasonably encompass, as well as any sub-ranges and combinations of sub-ranges encompassed therein.

In another aspect, polymerization can be effected at a range of temperatures, typically selected between the lowest temperature that affords reasonable polymerization rates, and the highest temperature allowable that does not result in substantial degradation or decomposition of the antimicrobial bioactive ingredient. In one aspect, the polymerization can be carried out at the lowest temperature possible such that polymerization proceeds. In this case, the polymerization temperature should be sufficiently low to not substantially degrade or decompose any bioactive ingredient that is incorporated, yet high enough such that polymerization rates and times are adequate for useful production of the final latex polymer.

The antimicrobial agent can also be fed as a pre-emulsion made by emulsifying a mixture of monomer, additive, surfactants, water, and the like, using methods and materials known to one of ordinary skill in the art. For example, In this aspect, the dispersions can be made, among other ways, by using a relatively concentrated amount of the additive and dispersing by using surfactants, dispersants, and the like, and typically employing a mixing device such as a high speed mixer, a homogenizer, an Eppenbach mixer, or similar devices. Moreover, any other conceivable process or process known to one of ordinary skill that provides emulsion polymers in which the additive is a dispersion, an emulsion, a suspension, or the like, or substantially dissolved in the monomer mixture prior to polymerization, can be utilized.

Typical amounts of bioactive component that can be added during the emulsion polymerization can range from about 0.01 percent to about 40 percent by weight bioactive additive, based on the total monomer weight. In another aspect, typical amounts of bioactive component that can be added during the emulsion polymerization can range from about 0.025 percent to about 35 percent, from about 0.05 percent to about 30 percent, from about 0.1 percent to about 25 percent, from about 0.25 percent to about 20 percent, or from about 0.5 percent to about 15 percent by weight bioactive additive, based on the total monomer weight. In this aspect, the intent is to disclose individually each possible number that such ranges could reasonably encompass, as well as any sub-ranges and combinations of sub-ranges encompassed therein. As compared to the amount of antimicrobial component added as a “post-add,” these concentrations of bioactive additive are typically much larger than the post-add amounts. Among other things, this feature provides stable, concentrated dispersions that can be used as concentrates, as additives, or as concentrated dispersions that can be diluted and added to other systems which require antimicrobial protection.

As disclosed herein, in one aspect, the bioactive component is typically dissolved in the monomer feed during the emulsion polymerization process. Thus, the bioactive additive is typically at least partially soluble in one or more of the monomers employed. Further, the bioactive additive can be moderately soluble, substantially soluble, or highly soluble in one or more of the monomers employed. This feature can allow, among other things, the incorporation of hydrophobic bioactive ingredients, the use of high amounts and concentrations of bioactive ingredients, greater control over the antimicrobial properties including enhancing the effectiveness of the antimicrobial properties, the use of minimal amounts of surfactant, and at least partial encapsulation of the bioactive ingredient. In some instances, the latex polymer can substantially encapsulate the added bioactive component, thus the latex polymer can function as a type of carrier for the active ingredients. This process also allows for the incorporation of the antimicrobial ingredients without substantially degrading the activity of these compounds.

In another aspect, useful bioactive additives can also be water soluble to any extent, including substantially water soluble, examples of which include o-phenylphenate (deprotonated o-phenylphenol), and similar agents. Thus, it is not necessary that such a hydrophilic bioactive additive be soluble in any monomer that is to be polymerized. In still another aspect, useful bioactive additives can be substantially insoluble in the monomers being polymerized and substantially insoluble in water. In this aspect, a dispersion of the bioactive component can be made by, among other ways, by dispersing a certain concentration of the additive with the use of surfactants and the like, typically with the use of high speed mixers or homogenizers.

Because the post-added additives are typically dispersions that are post-mixed into a formulation, it can be difficult to adequately disperse the bioactive additive into the polymer film, binder, coating, or the like, in which they are used. Moreover, typical additive dispersions that are used today can cause or be associated with moisture sensitivity and leaching of the additive, and many post-adds do not persist within the product for a sufficient period of time to provide adequate antifungal protection. The approach provided in this disclosure allows the use of minimal surfactants to incorporate the bioactive additives into the latex, and because the bioactives are introduced during the polymerization, they are typically encapsulated and are not easily released from the resulting latex. As a result, there can be less leaching of the bioactive component, and better overall distribution of the bioactive ingredient throughout the polymer film, binder, coating, and the like. Accordingly, this method can provide a potentially safer and more environmentally friendly dispersion, while also offering sustained antifungal or antibacterial protection.

The process disclosed herein also allows the latex to be used as a concentrate, in contrast to the typical concentrate dispersions that are not as stable as those provided herein. As a result, the typical concentrate dispersions are not as easily manipulated and therefore cannot be incorporated as easily into a finished product, and can have deleterious effects on performance, such as water sensitivity, if dosage is increased. A concentrate of the latex provided herein can be diluted and used with or without other materials if such materials are needed to provide an adequate level of additive. Intimate incorporation of an active ingredient in this manner can afford a homogeneous distribution of the additive and result in superior and sustained performance compared to a pre-made dispersions. An additional benefit of this intimate incorporation of the bioactive agent is apparent in films that are prepared using these lattices, which are observed to be substantially transparent. This feature highlights the highly homogeneous assimilation of the bioactive agent into the latex particles and how this uniform distribution can provide useful properties for applications such as transparent bioactive films and the like.

### Other Additives

In another aspect of this disclosure, the latex provided herein can also include other additives to improve the physical and/or mechanical properties of the polymer, the selection of which are known to one skilled in the art. Such additives include, for example, processing aids and performance aids, including but are not limited to, cross-linking agents, natural or synthetic binders, plasticizers, softeners, foam-inhibiting agents, froth aids, flame retardants, dispersing agents, pH-adjusting components, sequestering or chelating agents, or other functional components, or any suitable combination thereof.

### Exemplary Substrates and Applications for Bioactive Cationic Polymer Lattices

The latex particles can be included in latex dispersions, or present in powder form, and these powders and/or dispersions can be used in wallboard applications, for example, in the gypsum and/or in the paper layers. For example, one aspect relates to a treated fibrous material which includes at least one fiber and at least one bioactive cationic polymer latex. The treated fibrous material can include at least one fiber and at least one bioactive cationic polymer latex deposited on, or associated with, the at least one fiber. If desired, the bioactive cationic polymer can be applied to the fiber in the form of a powder, or the polymer composition can be deposited on the fiber by any suitable method known to the skilled artisan.

As used herein, the term “fiber” is intended to be construed as any fiber that can be associated with wallboard, wallboard paper, or pulp used for making wallboard paper, or any fiber used in the manufacture of wallboard, wallboard paper, or pulp used for making wallboard paper. The term “fiber” includes organic fibers or inorganic fibers associated with wallboard manufacture and natural or synthetic fibers associated with wallboard manufacture. Fiber can also include single or multiple filaments that can be present in a variety of ways. It should be appreciated that only a single fiber associated with wallboard manufacture can be treated with the bioactive cationic polymer latex if so desired.

In a further aspect, an article of manufacture can be associated with wallboard, including wallboard itself, and comprising a substrate and a bioactive cationic polymer latex deposited or positioned thereon, as provided herein. For the purposes of this disclosure, the term “substrate” is intended to be construed and interpreted as any substrate related to wallboard, to include all those formed from inorganic materials, organic materials, composites thereof, mixtures thereof, or any type combination thereof. For example, the substrate can encompass, but is not limited to, fibers, fillers, pigments, and the like, as well as other organic and inorganic materials that can be used in wallboard manufacture.

In this context, wallboard, including a bioactive cationic polymer latex deposited into, or onto, the gypsum and/or paper, can be made in accordance with standard procedures known to one of ordinary skill in the relevant art. The wallboard can have, for example, at least one other polymeric layer deposited thereon so as to form a composite structure, thus multiple polymeric layers of various types can be used if desired. For example, other layers of various polymers can be deposited on the bioactive cationic polymer latex which is present in the article of manufacture associated with wallboard, including wallboard itself, to form a composite structure. In this aspect, deposition of a bioactive cationic latex can be followed by the deposition of an anionic latex or other polymers to enhance specific properties of the wallboard. Thus, uniquely tailored articles associated with wallboard that have specially modified surfaces can be made in accordance with the present disclosure.

In a broader aspect, a coated material can comprise any material associated with wallboard manufacture and a bioactive cationic polymer latex deposited or positioned thereon, wherein additional layers of other materials optionally can be used in combination with the bioactive cationic polymer latex of this disclosure. As used herein, the term “material” is intended to be used to include, but not be limited to, any inorganic material, any organic material, any composite thereof, or any combination thereof that is associated with wallboard or wallboard manufacture. Examples of suitable materials include, but are not limited to, a fiber, a filler, a particle, a pigment, composites thereof, combinations thereof, mixtures thereof, and the like.

The present compositions and methods can afford certain advantages as compared to previous methods used to incorporate bioactive materials into wallboard applications. For example, a bioactive cationic latex can be substantially deposited on a substrate such that residual bioactive latex does not remain in the processing fluid medium, providing a potential advantage from an environmental standpoint. Moreover, bioactive cationic lattices can be preferentially deposited on any substrate that carries a net negative charge, and deposition can occur in a uniform manner, thereby using less latex polymer. Further to this aspect, and while not intending to be bound by theory, the bioactive cationic latex is thought to be capable of forming substantially uniform monolayers of polymer material on a negatively charged substrate, thereby allowing the use of less latex to provide the desired coverage. Because the bioactive cationic lattices can be formed by existing emulsion polymerization processes, the fabrication methods advantageously allow for the preparation of high molecular weight polymers.

The bioactive cationic polymer lattices disclosed herein can also obviate the need for cationic retention aids and cationic surfactants. In one aspect, for example, the bioactive cationic polymer lattices can be substantially devoid of cationic surfactants. This feature can be particularly desirable because cationic surfactants generally are not retained well and can cause foaming and other adverse effects in aquatic environments. However in another aspect, this disclosure also provides for the use of bioactive agents that can exhibit cationic surfactant behavior and/or for the use of retention aids and cationic surfactants as a particular application might necessitate. Moreover, if desired, the polymer lattices can be devoid of conventional surfactants including, for example, nonionic surfactants.

### Applications of Bioactive Cationic Polymer Lattices in Wallboard Manufacture

Wallboard is typically produced by enclosing a core of an aqueous slurry prepared using calcium sulfate hemihydrate, referred to as calcined gypsum, and other materials between two large sheets of wallboard cover paper. After the gypsum slurry has set and has been dried, the formed sheet is cut into standard sizes. Thus, the core of wallboard can be considered to be prepared by combining a “dry” portion and a “wet” or aqueous portion which is then situated between two sheets of cover paper, and which sets or hardens.

A major “dry” ingredient of the gypsum wallboard core is calcium sulfate hemihydrate, commonly referred to as calcined gypsum or stucco, which is prepared by drying, pulverizing, and calcining natural gypsum rock (calcium sulfate dihydrate). The drying step simply removes any free moisture that is not chemically bound in the rock, while calcining liberates a portion of the chemically bound water molecules. As a result, calcined gypsum has the desirable property of being chemically reactive with water, and will set rather quickly when the two are contacted and the calcium sulfate hemihydrate is rehydrated to its dihydrate state. In addition to calcium sulfate hemihydrate, the dry ingredients can include a wide range of additives, such as set retardants, set accelerators, antidesiccants, stabilizers, starch, and/or other additives that can be useful in the production process or the final wallboard properties.

In another aspect, the face paper and backing paper cover sheets used in wallboard manufacture are typically multi-ply paper manufactured from re-pulped paper materials (e.g. cardboard, paper, and/or newspaper). Both the face paper and the backing paper usually have an inner ply (typically unsized) which contacts the core slurry such that crystals of starch (conventionally added to the core slurry or gypsum slurry) can grow up to or into the inner ply. This starch crystal-paper interaction constitutes one principal form of bonding between the core slurry and the cover sheet. The middle plies are usually sized and an outer ply is more heavily sized and can be treated to control the absorption of paints and sealers.

Both cover sheets in wallboard manufacture typically have sufficient permeability to allow for water vapor to pass through during the downstream board drying process. In the present application, this benefit appears to arise from the fact that the bioactive latex does not diminish porosity, but rather maintains the porosity of the sheet while improving sizing. These and related methods for the production of gypsum wallboard generally are described, for example, in Michelsen, T. “Building Materials (Survey),” Kirk-Othmer Encyclopedia of Chemical Technology, (1992 4^{th} ed.), vol. 4, pp. 618-619.

One aspect provides an antimicrobial wallboard article of manufacture comprising at least one bioactive latex polymer disclosed herein, and also provides a process for making an antimicrobial gypsum wallboard comprising at least one bioactive latex polymer. In this aspect, the bioactive latex polymer can be used in any component of the wallboard, that is, as a component of the gypsum wallboard core, the first cover sheet, the second cover sheet, or any combination thereof. Thus, this method and article comprise adding at least one antimicrobial latex to the wallboard or any component thereof, at levels sufficiently effective against microbes, therefore, a bioactive latex is an optional ingredient of each wallboard component. Moreover, the at least one bioactive latex polymer can be used in any form, such as an emulsion, a dispersion, or in solid form, as disclosed herein. Thus in a further aspect, this disclosure provides for adding the at least one bioactive latex polymer in a finishing step such as coating, spraying, painting, or the like.

In a further aspect, bioactive cationic polymer lattices can be used as binder or coating materials that can be combined with paper pulp used to prepare the face paper and backing paper cover sheets in wallboard manufacture. In this aspect, either or both sheets of the wallboard cover paper can comprise at least one bioactive cationic polymer latex disclosed herein, which can be the same or can be different. These bioactive cationic lattices can be used to prepare the inner, middle, or outer plies of the cover sheets, or any combination thereof. In one aspect, one advantage of incorporating at least one bioactive cationic polymer latex by addition to the paper pulp, occurs because the cationic latex is attracted to the paper fibers which can provide a substantially uniform deposition of the cationic latex on the fiber, and a substantially homogeneous product. Moreover, any combination of cover sheets in which the first, the second, or both covers sheets comprise antimicrobial components can be used with a gypsum slurry that comprises at least one bioactive cationic polymer latex, or with a gypsum slurry that does not comprise at least one bioactive cationic polymer latex.

Thus in one aspect, this disclosure provides a method of making an antimicrobial wallboard comprising:
a) forming a slurry comprising calcium sulfate hemihydrate, water, paper pulp, and optionally at least one first bioactive cationic polymer latex;
b) depositing the slurry onto a first cover sheet optionally comprising at least one second bioactive cationic polymer latex; and
c) applying a second cover sheet optionally comprising at least one third bioactive cationic polymer latex on top of the deposited slurry; and
d) drying the resulting wallboard;
wherein at least one of the slurry, the first cover sheet, or the second cover sheet comprises at least one bioactive cationic polymer latex; and
wherein the at least one first bioactive cationic polymer latex, the at least one second bioactive cationic polymer latex, and the at least one third bioactive cationic polymer latex each comprises, independently, at least one bioactive component independently selected from triclosan, propiconazole, tebuconazole, zinc pyrithione, sodium pyrithione, triclocarban, diiodomethyl-4-tolylsulfone, thiabendazole, 3-iodo-2-propynyl butylcarbamate, tolyl diiodomethyl sulfone, or any combination thereof.

Thus, the at least one first, the at least one second, and at least one third bioactive cationic polymer lattices are selected independently of each other. Any of the bioactive cationic polymer lattices or combinations of bioactive cationic polymer lattices disclosed herein can be employed in any of the antimicrobial wallboard components.

Accordingly, an antimicrobial wallboard comprises:
a) a gypsum core optionally comprising at least one first bioactive cationic polymer latex;
b) a first cover sheet disposed on one side of the gypsum core and optionally comprising at least one second bioactive cationic polymer latex; and
c) a second cover sheet disposed on the opposite side of the gypsum core and optionally comprising at least one third bioactive cationic polymer latex;
wherein at least one of the gypsum core, the first cover sheet, or the second cover sheet comprises at least one bioactive cationic polymer latex; and
wherein the at least one first bioactive cationic polymer latex, the at least one second bioactive cationic polymer latex, and the at least one third bioactive cationic polymer latex each comprises, independently, at least one bioactive component independently selected from triclosan, propiconazole, tebuconazole, zinc pyrithione, sodium pyrithione, triclocarban, diiodomethyl-4-tolylsulfone, thiabendazole, 3-iodo-2-propynyl butylcarbamate, tolyl diiodomethyl sulfone, or any combination thereof.

Although any methods, devices, and materials similar or equivalent to those described herein can be used in the practice or testing of the compositions, articles and methods disclosed herein, it is the typical methods, devices and materials that have been herein described. The publications discussed herein are provided solely for their disclosure prior to the filing date of the present application. Nothing herein is to be construed as an admission that the inventors are not entitled to antedate such disclosure by virtue of prior invention.

When the disclosure mentions or claims a range of any type, for example a range of temperatures, a range of concentrations, a range of numbers of atoms, a weight percent, or the like, the intent herein is to disclose or claim individually each possible number that such a range could reasonably encompass, as well as any sub-ranges and combinations of sub-ranges encompassed therein. Thus, when a chemical moiety having a certain number of carbon atoms is disclosed or claimed, the intention is to disclose or claim individually every possible number, sub-range, and combination of sub-ranges that such a number range could encompass, consistent with the disclosure herein. For example, the disclosure that R is selected from an alkyl group having up to 12 carbon atoms, or in alternative language a C₁ to C₁₂ alkyl group, as used herein, refers to an R group that can be selected from an alkyl group having 1, 2, 3, 4, 5, 6, 7, 8, 9, 10, 11, or 12 carbon atoms, as well as any range between these two numbers for example a C₃ to C₈ alkyl group, and also including any combination of ranges between these two numbers for example a C₃ to C₅ and C₇ to C₁₀ alkyl group. Thus, the right is retained to replace the terminology such as “group having up to 12 carbon atoms” with any individual number that such a range could reasonably encompass, as well as any sub-ranges and combinations of sub-ranges encompassed therein. In another example, by the disclosure that the molar ratio typically spans the range from about 0.1 to about 1.0, the intent is to recite that the molar ratio can be selected from about 0.1:1, about 0.2:1, about 0.3:1, about 0.4:1, about 0.5:1, about 0.6:1, about 0.7:1, about 0.8:1, about 0.9:1, or about 1.0:1, as well as any sub-ranges and combinations of sub-ranges encompassed therein. Similarly, the disclosure that a particular weight percent can be from about 80 percent to about 90 percent by weight, the intention herein is to recite that the weight percent can be about 80 percent, about 81 percent, about 82 percent, about 83 percent, about 84 percent, about 85 percent, about 86 percent, about 87 percent, about 88 percent, about 89 percent, or about 90 percent, by weight.

The right is reserved herein to proviso out or exclude any individual members of any such group, including any sub-ranges or combinations of sub-ranges within the group, that may be claimed according to a range or in any similar manner, if for any reason a claim to less than the full measure of the disclosure is presented, for example, to account for a reference unknown of at the time of the filing of the application. Further, the right is reserved to proviso out or exclude any individual substituents, additives, compounds, monomers, surfactants, structures, and the like, or any groups thereof, or any individual members of a claimed group, if for any reason a claim is presented to less than the full measure of the disclosure, for example, to account for a reference unknown at the time of the filing of the application.

For any particular chemical compound disclosed herein, any general disclosure or structure presented also encompasses all isomers, such as conformational isomers, regioisomers, stereoisomers, and the like, that can arise from a particular set of substituents. The general structure also encompasses all enantiomers, diastereomers, and other optical isomers whether in enantiomeric or racemic forms, as well as mixtures of stereoisomers, as the context requires.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, may suggest themselves to one of ordinary skill in the art without departing from the spirit of the present disclosure or the scope of the appended claims.

In the following examples, unless otherwise specified, the reagents were obtained from commercial sources. General procedures, including general synthetic testing procedures for cationic polymer lattices, are provided in U.S. Patent Application Publication Numbers 2005/0065284 and 2005/0003163, to Krishnan.

### Example 1

### Bioactive Cationic Latex Prepared by Early Introduction of the Bioactive Agent

A one-gallon reactor can be charged with the following ingredients: about 1142 g of water; about 5.95 g of the nonionic surfactant ABEX™ 2525 (Rhodia); about 11.90 g of methoxy polyethyleneglycolmethacrylate (MPEG 550 from Cognis); and about 31.7 g of dimethylaminoethyl methacrylate methyl chloride quaternary (AGEFLEX™ FM1Q75MC from Ciba Specialty Chemicals). The reactor contents then can be deoxygenated by subjecting the reactor to several vacuum/N₂ fill cycles, after which about 59.5 g of butyl acrylate and about 119 g of styrene can be added to the reactor. The reactor is again subjecting to several vacuum/N₂ fill cycles, after which the temperature of the reactor contents can be increased to about 165° F., at which time an initiator solution of about 23.80 g of water and about 2.38 g of WAKO V-50 (Wako Chemicals) is injected into the reaction mixture. This reaction mixture is maintained at about 165° F. for approximately 30 minutes before starting the following feeds into the reactor:
1) A butadiene feed consisting of about 238 g of butadiene, fed over about 5 hours;
2) A mixed monomer feed of about 102 g of butyl acrylate, about 517 g of styrene, and about 119 g of any suitable bioactive agent such as those disclosed herein. The total feed time of the entire mix can be about 5 hours. The bioactive ingredient can be introduced into the mixed monomer feed after about 1 hour of the mixed monomer feed, which involves dissolving about 119 g of the bioactive agent in about 495 g of the styrene/butyl acrylate monomer mixture that is introduced into the reactor over the final 4-hour feed period of the mixed monomer feed;
3) An aqueous monomer feed consisting of about 152 g of water, about 47.60 g of MPEG 550 (Cognis), about 47.60 g of dimethyl aminoethylmethacrylate methyl chloride quaternary (AGEFLEX™ FM1Q75MC from Ciba Specialty Chemicals), and about 74.5 g of N-methylol acrylamide. This aqueous monomer feed can be fed into the reactor over an approximately 3-hour period; and
4) An aqueous initiator feed consisting of about 202 g of water and about 4.8 g of WAKO™ V-50, which can be fed into the reactor over about 5.5 hours;

When addition of the feeds is completed, the reaction is continued until most (greater than about 98%) of the monomers have reacted. The reactor contents are then cooled down and the vacuum stripped to remove unreacted monomers and to raise the solids concentration to about 40 percent by weight. If necessary or desired, the pH of the latex can be adjusted as required before stripping the reaction volatiles.

### Example 2

### Bioactive Cationic Latex Prepared by Late Introduction of the Bioactive Agent

An emulsion polymerization reaction can be conducted according to the details provided in Example 2, except that an approximately 49 g-sample of bioactive component can be introduced into the mixed monomer stream after about 4 hours of a 5 hour styrene/butyl acrylate feed. This process involves dissolving the bioactive agent in about 124 g of the styrene/butyl acrylate monomer mixture that is introduced into the reactor over the final 1-hour feed period of the mixed monomer feed.

### Example 3

### Wallboard Paper Treated with Bioactive Cationic Latex Compositions

Latex compositions as described herein were further evaluated by painting them on the face paper cover of wallboard (three coats). The painted wallboards were then placed in a fungal chamber for microbiological testing in accordance with ASTM (American Society for Testing and Materials Standards) D3273 (“Standard Test Method for Resistance to Growth of Mold on the Surface of Interior Coatings in an Environmental Chamber”). The D3273 test was performed using various cationic latex compositions having one or more antimicrobial agents incorporated therein.

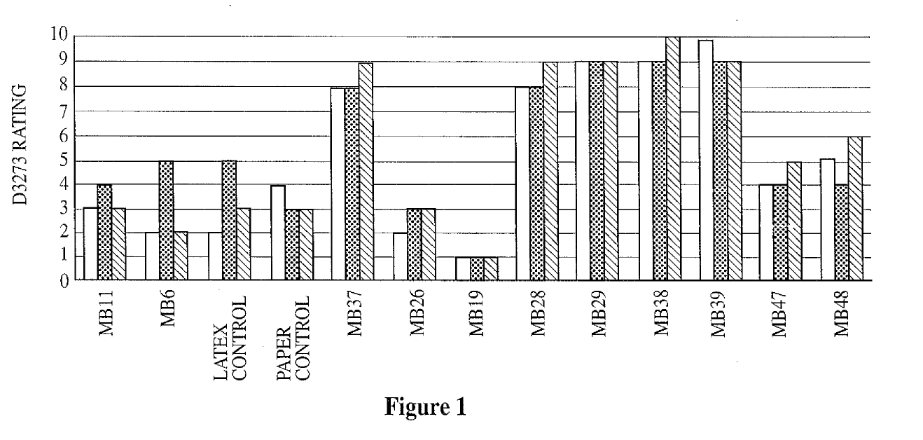

Data presented in FIG. 1 represents the following compositions: MB1, a low-cationic latex; MB6, a high-cationic latex; MB1045-83, a latex negative control (no antimicrobial agent); MB37, 10,000 ppm diiodomethyl-p-tolylsulfone; MB28, 1000 ppm sodium ortho-phenyl phenol and 1000 ppm tebuconazole; MB29, 2000 sodium ortho-phenyl phenol and 2000 ppm tebuconazole; MB38, 1000 ppm propiconazole and 1000 ppm tebuconazole; MB39, 2000 ppm propiconazole and 2000 ppm tebuconazole; and MB48, 4000 ppm zinc pyrithione.

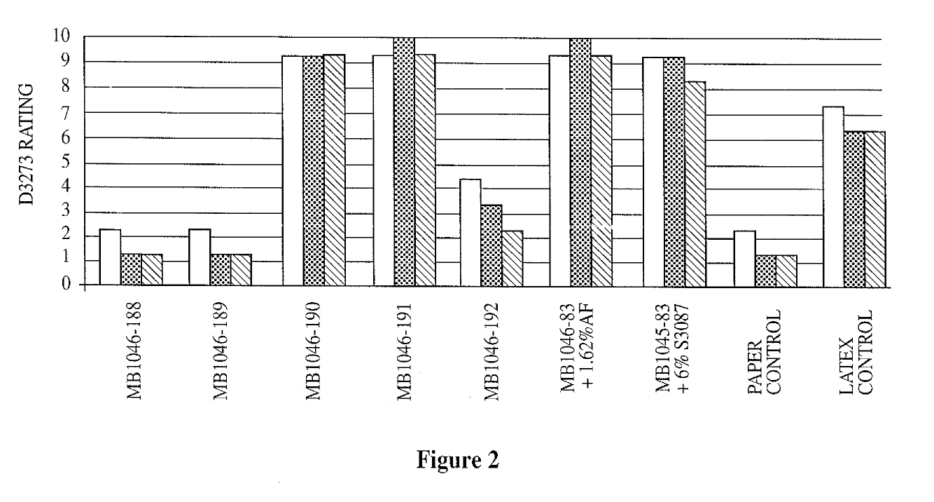

FIG. 2 shows data from: MB1046-188, 1.22% diiodomethyl-p-tolylsulfone; MB1046-190, 4200 ppm propiconazole and 4200 ppm tebuconazole; MB1046-191, 8400 ppm propiconazole and 8400 ppm tebuconazole; MB1045-83 with 1.62% diiodomethyl-p-tolylsulfone; MB1045-83 with 8400 ppm propiconazole and 8400 ppm tebuconazole; uncoated wallboard paper; and MB1045-83 negative control.

Before the painted wallboards were placed in the chamber, a small piece (0.5″×0.5″) was cut from each of the wallboard sample and analyzed to determine the actual amount of antifungal actives painted on the wallboard cover paper.

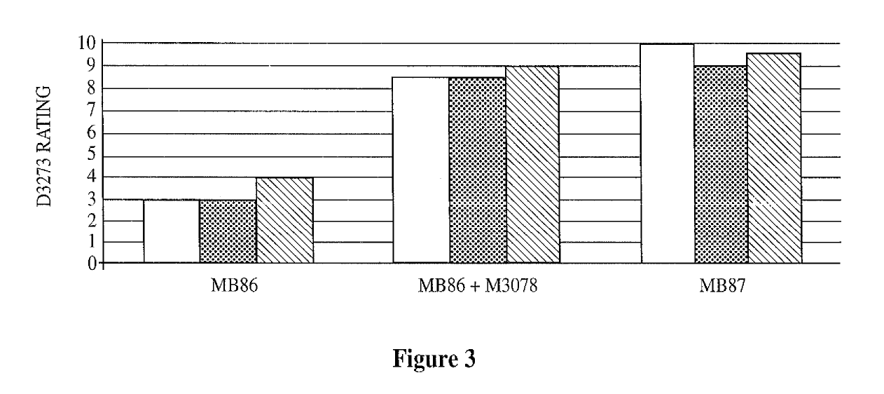

Finally, paper handsheets were prepared and assessed by ASTM D3273 (FIG. 3). The treatments included: MB86 (designating paper handsheet with latex only); MB86+M3078 (designating paper with latex made by post-addition of 1000 ppm propiconazole, 1000 ppm tebuconazole and 1000 ppm alkyl dimethylbenzyl ammonium saccharide); and MB87 (designating paper handsheet having 1000 ppm propiconazole and 1000 ppm tebuconazole from a latex composition having propiconazole and tebuconazole incorporated during polymerization as disclosed herein).

The propiconazole/tebuconazole latex-treated samples demonstrated good antifungal performance (9/9/10) at an application rate of about 150/140 ppm based on the weight of the wallboard cover paper (FIG. 1). The 150/140 ppm concentration was obtained from analytical data of the cover paper. According to analytical results in FIG. 3, the actual amount of propiconazole/tebuconazole to which fungi were exposed was approximately 1500 ppm.

Both methods of addition of propiconazole/tebuconazole TZ into the paper wet end process (that is, post-addition as well as addition of latex having antimicrobial agent(s) incorporated therein) provide antifungal protection to the paper hand sheets, with the use of latex compositions as disclosed herein observed to provide an increased efficacy over post-addition samples. It should be noted that the D3273 assay does not assess durability.

Retention of antifungal agents onto paper at wet end processing was significantly improved when the antifungal agents was loaded into cationic latex particles and applied as such. One benefit to this approach is the stable emulsion of antifungal agents, an elusive goal in the conventional applications of antifungal agents. Better retention also was observed of the antifungal agents on/in the paper, presumably due to the opposite surface charge carried by the cationic latex and the paper.

### Example 4

### Evaluation of Cationic Latex Incorporating Antifungal Agents

Antifungal wallboard was identified as a target for the evaluation of a cationic latex incorporating an antifungal agent. The goal of this example was to deliver the antifungal agent is through a cationic polymer incorporated into the paper facing of the gypsum wallboard in a conventional wet end process used for paper making.

Several cationic polymers were made, with a variety of antifungal additives incorporated into the polymers during the polymerization process, at various levels. The polymers were tested both as coatings on paper as well as by addition in a wet end process. The main antifungal evaluations were conducted based on ASTM G-21 and ASTM D-3273, which showed that the best antifungal results were obtained using a combination of two antifungal additives (propiconazole (“PZ”) and tebuconazole (“TZ”)).

The coating study indicated that a PZ/TZ level of 0.4% on a wet basis had a significant inhibitory effect, and that the PZ/TZ could be transported through the wet end and deposit cleanly on the paper. A series of cationic polymers (without any additive incorporated into the polymers) were evaluated for antibacterial properties (both low and high levels of cationic monomer) using AATCC-100 method. The polymers showed >99% kill, whereas a control polymer that was not cationic did not show any kill.

### Results and Discussions:

The antifungal additives used in this study are shown in Table-1

TABLE 1
List of additives used in polymerization

| Additive | Chemical | | |
|---|---|---|---|
| Name | description | Primary use | Solubility |
| Amical AF | Diiodomethyltoluyl | Antifungal | Tan solid. |
| | sulfone | | Limited |
| | | | solubility in |
| | | | monomer |
| Microban PZ | Propiconazole | Antifungal | Waxy solid |
| | | | when pure. |
| | | | Fairly soluble |
| Microban TZ | Tebuconazole | Antifungal | White solid. |
| | | | Fairly soluble |
| Microban P2 | Sodium | Antibacterial | Solid. Water |
| | orthophenyl | | soluble |
| | phenate | | |
| Triclosan | Chlorodiphenyl | Antibacterial | Solid. Fairly |
| | ether | | soluble in |
| | | | monomer |
| Microban Z01 | Zinc pyrithione | Antifungal | Solid. |
| | | | Insoluble in |
| | | | monomer |

Ideally, the materials are substantially unreactive during the polymerization conditions, so they are not degraded during polymerization. In some embodiments, low levels of additive might be observed, whether due to degradation, or difficulty in extraction from the polymer latex. In any case, retention of the additive in the latex leads to retention of antifungal properties in the finished paper.

Initial polymerization work with Amical showed that the Amical was degraded when it was incorporated in relatively high amounts. The polymerization temperature was investigated as a potential contributor to degradation, and it was kept as low as was feasible (typically <70° C.). The samples were stripped at the end of polymerization to the desired solids content.

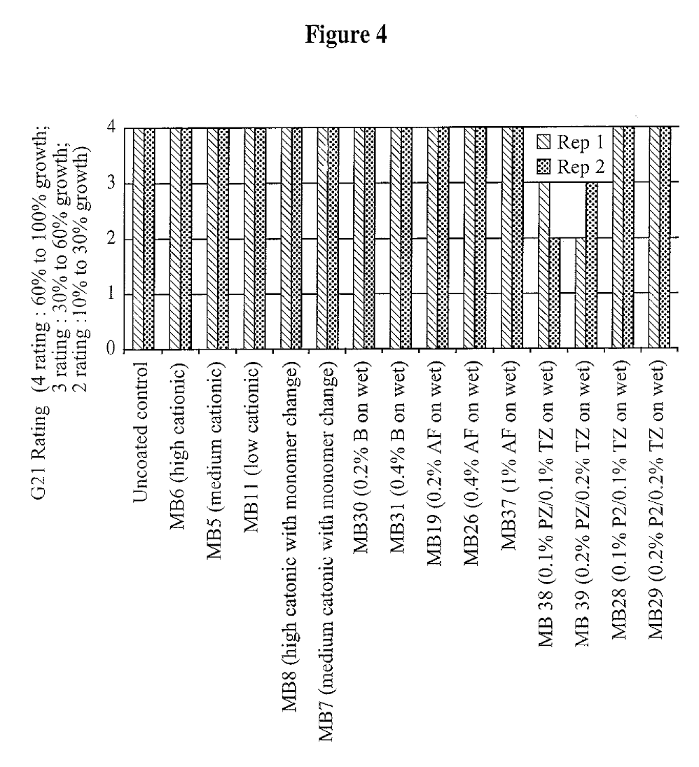

Initial testing of the samples is shown in Table-2. This testing involved ASTM G-21, in which fungi were inoculated directly on the coated paper samples and then maintained in a humidity chamber for 28 days. The latex coating was applied on the paper using a #10 Meyer rod, and only a single coat was applied. However, it was determined that this was not an adequate coating thickness, considering that the paper may not have been fully covered, and this is reflected in the fungal growth data shown in FIG. 4.

The latex samples with the PZ/TZ combination (MB-38, MB-39) exhibited potent fungal inhibition characteristics.

Additive levels recovered from the latex samples were determined and compared with the amounts of additives originally added. This data is summarized in Table-2.

TABLE 2
Analytical data on the additive levels in latex

| | Actives loaded into cationic | |
|---|---|---|
| | latex particles during | Analytical based |
| 40% solid latex | polymerization (ppm based on | on wet latex |
| emulsions | weight of wet latex emulsion) | emulsion (ppm) |
| MB37 (AF) | 10000 | 95 |
| MB26 (AF) | 4000 | 38 |
| MB19 (AF) | 2000 | 19 |
| MB28 (P2/TZ) | 1000/1000 | 14/790 |
| MB29 (P2/TZ) | 2000/2000 | 310/330 |
| MB 38 (PZ/TZ) | 1000/1000 | 620/620 |
| MB 39 (PZ/TZ) | 2000/2000 | 1700/1400 |
| MB47 (ZO1) | 2000 | 0 |
| MB48 (ZO1) | 4000 | 190 |
| MB30 (B) | 2000 | 1600 |

In this example, Amical tended to be poorly incorporated into the latex even when significant amounts were added during polymerization. Significant amounts of the PZ/TZ combination, as well as triclosan, were recovered.

The results observed in the G-21 study were also duplicated in a shorter (7 day incubation) fungal study (referred to herein as 30-III). Microban Z01, zinc pyrithione at 0.4% (wet basis), and PZ/TZ all performed well.

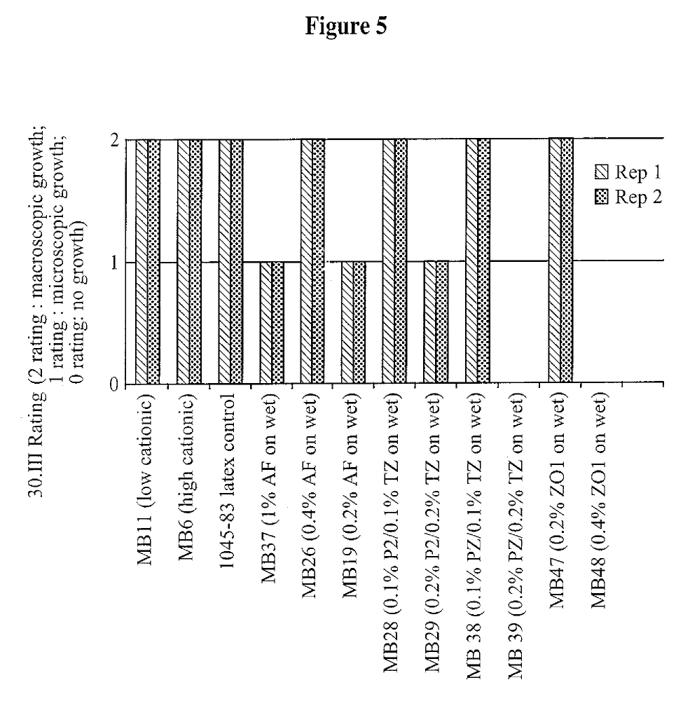

The 30-III fungal test was based on making a 1″X1″ chip of the dried latex and inoculating the fungal species directly on to the sample and then observing its growth after 7 days. This is not as rigorous a test as the G-21 test, but gave a quick indication of the efficacy of the additives. In this test, the Amical samples showed some fungal inhibition. The results are shown in FIG. 5.

In this test, the cationic polymers by themselves, without any additive, did not exhibit significant fungal resistance qualities. Variation of the cationic charge did not seem to affect the antifungal performance. This is in contrast to a different antifungal test where a polymer film was inoculated with a fungal species and left in a humidity chamber for 6 months without any fungal growth. One reason for this result could be that the films tested were much thicker films (about 4 mils or 100 microns) than those tested here.

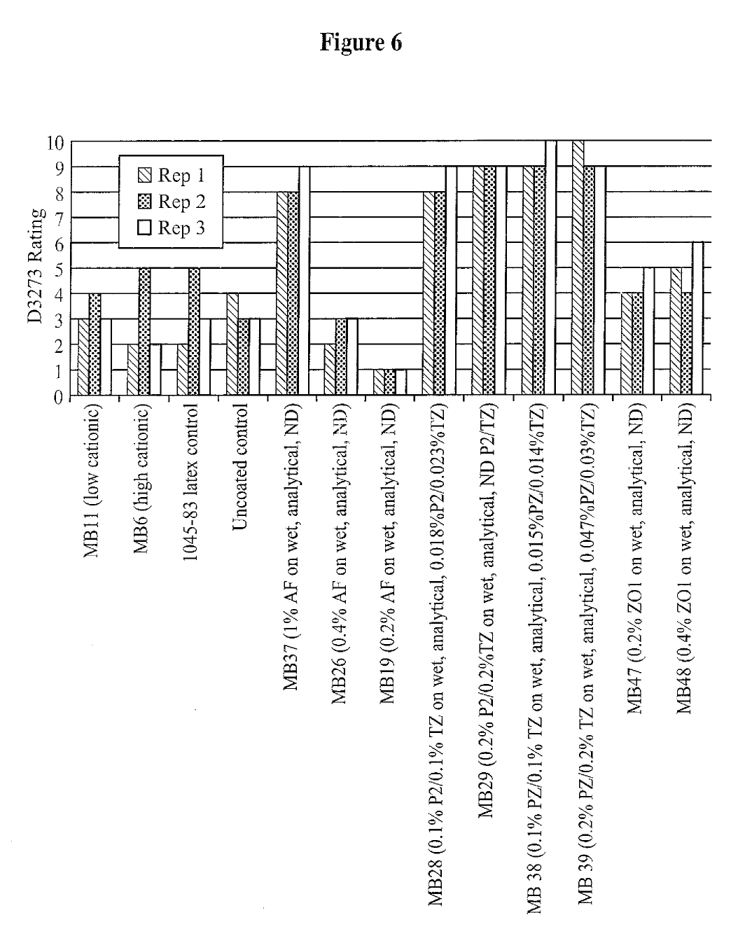

A second round of testing was performed using an increased coating thickness to ensure full coverage of the paper surface. The second round of testing of the coated paper samples were tested according to ASTM D-3273. In this study, the duration remained the same (28 days), but the fungal species were not directly inoculated on the surface. Rather, they were maintained in the humidity chamber as spores that would then land on the surface of the coated paper as in a real world example. The results of this study are outlined in FIG. 6.

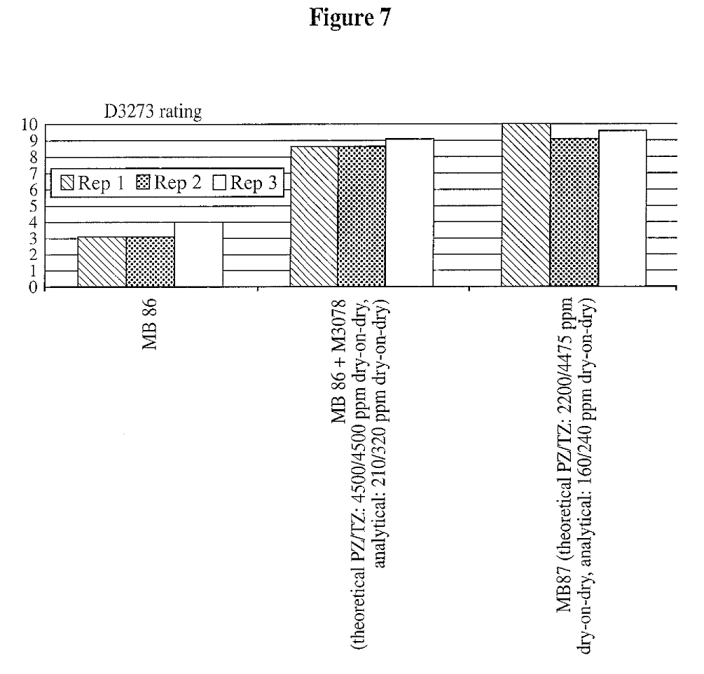

In this study, Amical and PZ/TZ were effective, but Z01 did not perform well. The cationic polymers without any additive also did not seem to show antifungal properties, and appeared to be similar to the uncoated paper samples. The analytical data shown in FIG. 7 was based on measurements of the coated sample before the start of the fungal study. The recovery of the additive from the paper is not quantitative.

The next phase of the study was to demonstrate that the same performance could be obtained through the wet end process same as in coated paper. The deposition of latex on to paper involved depositing a fixed amount of latex (10% based on fiber) on to softwood fibers and sending these for antifungal evaluations. The amount of additive in the latex was around 7.5% (in one sample, 2.5% PZ and 5% TZ by weight). This data is summarized in FIG. 7. In this study, paper samples were made using the cationic latex with (MB-87) and without the PZ/TZ additive (MB-86). As mentioned earlier, the amount of PZ/TZ additive in the latex was 7.5% (dry basis). This would give about 6680 ppm of PZ/TZ in the finished paper and 10% polymer or latex on a fiber basis weight.

A dispersion of PZ/TZ (M-3078) was also provided, with an activity of 28%. This was used as a post add with the cationic latex MB-86 to give essentially the same amount of PZ/TZ. Hence, the post added sample with the dispersion had a PZ/TZ concentration of about 10%, much more than that of the polymerized latex sample, and would result in a PZ/TZ concentration of around 9000 ppm in the finished paper. The antifungal results of the plain latex (MB-86), MB-86 with post added PZ/TZ, and the polymerized PZ/TZ sample MB-87 is shown in FIG. 7.

Just as in the coated sample study, the paper with just the cationic latex did not pass the fungal D-3273 test. Both the post added and the polymerized PZ/TZ samples passed the test. It should be noted that the polymerized additive sample (MB-87) had ˜3000 ppm less of the PZ/TZ, but still seemed to perform as well as or slightly better than the post added sample. No fungal growth was observed.

In the specification, typical embodiments have been disclosed and, although specific terms are employed, they are used in a generic and descriptive sense and not for purposes of limitation. It should be clearly understood that resort can be had to various other embodiments, aspects, modifications, and equivalents to those disclosed in the claims, which, after reading the description herein, may suggest themselves to one of ordinary skill in the art without departing from the spirit of the present disclosure or the scope of these claims. The following claims are provided to ensure that the present application meets all statutory requirements as a priority application in all jurisdictions and shall not be construed as setting forth the full scope of the latex composition, methods for use of same, and articles incorporating or containing same that are disclosed herein.

What is claimed is:

1. An antimicrobial wallboard, comprising:
a) a gypsum core optionally comprising at least one first bioactive cationic polymer latex;
b) a first cover sheet disposed on one side of the gypsum core and optionally comprising at least one second bioactive cationic polymer latex; and
c) a second cover sheet disposed on the opposite side of the gypsum core and optionally comprising at least one third bioactive cationic polymer latex; and
wherein at least one of the gypsum core, the first cover sheet, or the second cover sheet comprises at least one bioactive cationic polymer latex,
wherein the at least one first bioactive cationic polymer latex, the at least one second bioactive cationic polymer latex, and the at least one third bioactive cationic polymer latex each comprises, independently, at least one bioactive component independently selected from triclosan, propiconazole, tebuconazole, zinc pyrithione, sodium pyrithione, triclocarban, diiodomethyl-4-tolylsulfone, thiabendazole, 3-iodo-2-propynyl butylcarbamate, tolyl diiodomethyl sulfone, or any combination thereof.

2. The antimicrobial wallboard of claim 1 wherein the at least one bioactive component comprises at least one first antimicrobial agent and at least one second antimicrobial agent;
wherein the at least one first antimicrobial agent is propiconazole, sodium pyrithione, or any combination thereof; and
wherein the at least one second antimicrobial agent is tolyl diiodomethyl sulfone, tebuconazole, thiabendazole, 3-iodo-2-propynyl butylcarbamate, or any combination thereof.

3. The antimicrobial wallboard of claim 1 wherein the at least one first bioactive cationic polymer latex, the at least one second bioactive cationic polymer latex, and the at least one third bioactive cationic polymer latex each is comprised of, independently:
a) a latex polymer comprising the polymerization product of:
i) at least one ethylenically unsaturated first monomer, and
ii) at least one ethylenically unsaturated second monomer that is cationic or a precursor to a cation;
b) at least one bioactive component at least partially encapsulated within the latex polymer; and
c) optionally, at least one sterically bulky component incorporated into the latex polymer.

4. The antimicrobial wallboard of claim 3 wherein the at least one first bioactive cationic polymer latex, the at least one second bioactive cationic polymer latex, and the at least one third bioactive cationic polymer latex each further comprises, independently, a nonionic surfactant.

5. The antimicrobial wallboard of claim 3 wherein the at least one first bioactive cationic polymer latex, the at least one second bioactive cationic polymer latex, and the at least one third bioactive cationic polymer latex, independently, is substantially devoid of cationic and anionic surfactants.

6. The antimicrobial wallboard of claim 3 wherein the at least one ethylenically unsaturated first monomer is selected independently from a vinyl aromatic monomer, a halogenated or a non-halogenated olefin monomer, an aliphatic conjugated diene monomer, a non-aromatic unsaturated mono- or dicarboxylic ester monomer, a monomer based on the half ester of an unsaturated dicarboxylic acid monomer, an unsaturated mono- or dicarboxylic acid monomer, a nitrile-containing monomer, a cyclic or an acyclic amine-containing monomer, a branched or an unbranched alkyl vinyl ester monomer, a halogenated or non-halogenated alkyl acrylate monomer, a halogenated or non-halogenated aryl acrylate monomer, a carboxylic acid vinyl ester, an acetic acid alkenyl ester, a carboxylic acid alkenyl ester, a vinyl halide, a vinylidene halide, or any combination thereof, any of which having up to 20 carbon atoms.

7. The antimicrobial wallboard of claim 3 wherein the at least one ethylenically unsaturated first monomer is selected independently from styrene, para-methyl styrene, chloromethyl styrene, vinyl toluene, ethylene, butadiene, methyl (meth)acrylate, ethyl (meth)acrylate, propyl (meth)acrylate, butyl (meth)acrylate, pentyl (meth)acrylate, glycidyl (meth)acrylate, isodecyl (meth)acrylate, lauryl (meth)acrylate, monomethyl maleate, itaconic acid, (meth)acrylonitrile, (meth)acrylamide, N-methylol (meth)acrylamide, N-(isobutoxymethyl)(meth)acrylamide, vinyl neodecanoate, vinyl versatates, vinyl acetate, a C₃-C₈ alkyl vinylether, a C₃-C₈ alkoxy vinylether, vinyl chloride, vinylidene chloride, vinyl fluoride, vinylidene fluoride, trifluoroethylene, tetrafluoroethylene, chlorotrifluoroethylene, hexafluoropropylene, chlorotrifluoroethylene, perfluorobutyl ethylene, a perfluorinated C₃-C₈ alpha-olefin, a fluorinated C₃-C₈ alkyl vinylether, a perfluorinated C₃-C₈ alkyl vinylether, a perfluorinated C₃-C₈ alkoxy vinyl ether, or any combination thereof.

8. The antimicrobial wallboard of claim 3 wherein the at least one ethylenically unsaturated second monomer is selected independently from an amine monomer, an amide monomer, a quaternary amine monomer, a phosphonium monomer, a sulfonium monomer, or any combination thereof, any of which having up to 20 carbon atoms.

9. The antimicrobial wallboard of claim 3 wherein the at least one ethylenically unsaturated second monomer is selected independently from dimethylaminoethyl acrylate; diethylaminoethyl acrylate; dimethyl aminoethyl methacrylate; diethylaminoethyl methacrylate; tertiary butylaminoethyl methacrylate; N,N-dimethyl acrylamide; N,N-dimethylaminopropyl acrylamide; acryloyl morpholine; N-isopropyl acrylamide; N,N-diethyl acrylamide; dimethyl aminoethyl vinyl ether; 2-methyl-1-vinyl imidazole; N,N-dimethyl-aminopropyl methacrylamide; vinyl pyridine; vinyl benzyl amine; dimethylaminoethyl acrylate, methyl chloride quaternary; dimethylaminoethyl methacrylate, methyl chloride quaternary; diallyldimethylammonium chloride; N,N-dimethylaminopropyl acrylamide, methyl chloride quaternary; trimethyl-(vinyloxyethyl)ammonium chloride; 1-vinyl-2,3-dimethylimidazolinium chloride; vinyl benzyl amine hydrochloride; vinyl pyridinium hydrochloride; or any combination thereof.

10. The antimicrobial wallboard of claim 3 wherein the at least one sterically bulky component is selected independently from at least one sterically bulky ethylenically unsaturated third monomer, at least one sterically bulky polymer, or any combination thereof.

11. The antimicrobial wallboard of claim 3 wherein the at least one sterically bulky component is at least one a sterically bulky ethylenically unsaturated third monomer selected independently from:
a) CH₂═C(R^{1A})COO(CH₂CHR^{2A}O)ₘR^{3A}, wherein R^{1A}, R^{2A}, and R^{3A} are selected independently from H or an alkyl group having from 1 to 6 carbon atoms, inclusive, and m is an integer from 1 to 30, inclusive;
b) CH₂═C(R^{1B})COO(CH₂CH₂O)ₙ(CH₂CHR^{2B}O)ₚR^{3B}, wherein R^{1B}, R^{2B}, and R^{3B} are selected independently from H or an alkyl group having from 1 to 6 carbon atoms, inclusive, and n and p are integers selected independently from 1 to 15, inclusive;
c) CH₂═C(R^{1C})COO(CH₂CHR^{2C}O)_{q}(CH₂CH₂)ᵣR^{3C}, wherein R^{1C}, R^{2C}, and R^{3C} are selected independently from H or an alkyl group having from 1 to 6 carbon atoms, inclusive, and q and r are integers selected independently from 1 to 15, inclusive; or
d) any combination thereof.

12. The antimicrobial wallboard of claim 3 wherein the at least one sterically bulky component is selected independently from: an alkoxylated monoester of a dicarboxylic acid; an alkoxylated diester of a dicarboxylic acid; a polyoxyethylene alkylphenyl ether; a polymerizable surfactant; or any combination thereof.

13. The antimicrobial wallboard of claim 3 wherein the at least one sterically bulky component is at least one sterically bulky polymer selected independently from polyvinyl alcohols, polyvinyl pyrollidone, hydroxyethyl cellulose, or any combination thereof.

14. The antimicrobial wallboard of claim 3 wherein the at least one first bioactive cationic polymer latex, the at least one second bioactive cationic polymer latex, and the at least one third bioactive cationic polymer latex each is comprised of, independently, from about 20 percent to about 99.5 percent by weight of the ethylenically unsaturated first monomer, based on the total monomer weight.

15. The antimicrobial wallboard of claim 3 wherein the at least one first bioactive cationic polymer latex, the at least one second bioactive cationic polymer latex, and the at least one third bioactive cationic polymer latex each is comprised of, independently, from about 0.01 percent to about 75 percent by weight of the ethylenically unsaturated second monomer, based on the total monomer weight.

16. The antimicrobial wallboard of claim 3 wherein the at least one first bioactive cationic polymer latex, the at least one second bioactive cationic polymer latex, and the at least one third bioactive cationic polymer latex each is comprised of, independently, from about 0.01 percent to about 40 percent by weight bioactive additive, based on the total monomer weight.

17. The antimicrobial wallboard of claim 3 wherein the at least one first bioactive cationic polymer latex, the at least one second bioactive cationic polymer latex, and the at least one third bioactive cationic polymer latex each is comprised of, independently, up to about 25 percent by weight sterically bulky component, based on the total monomer weight.

18. A method of making an antimicrobial wallboard, comprising:
a) forming a slurry comprising calcium sulfate hemihydrate, water, paper pulp, and optionally at least one first bioactive cationic polymer latex;
b) depositing the slurry onto a first cover sheet optionally comprising at least one second bioactive cationic polymer latex; and
c) applying a second cover sheet optionally comprising at least one third bioactive cationic polymer latex on top of the deposited slurry; and
d) drying the resulting wallboard;
wherein at least one of the slurry, the first cover sheet, or the second cover sheet comprises at least one bioactive cationic polymer latex,
wherein the at least one first bioactive cationic polymer latex, the at least one second bioactive cationic polymer latex, and the at least one third bioactive cationic polymer latex each is comprised of, independently, at least one bioactive component independently selected from the group consisting of triclosan, propiconazole, tebuconazole, zinc pyrithione, sodium pyrithione, triclocarban, diiodomethyl-4-tolylsulfone, thiabendazole, 3-iodo-2-propynyl butylcarbamate, tolyl diiodomethyl sulfone, and a combination thereof.

19. The method of claim 18 wherein any of the wherein the at least one first bioactive cationic polymer latex, the at least one second bioactive cationic polymer latex, and the at least one third bioactive cationic polymer latex comprises at least one first antimicrobial agent selected from the group consisting of propiconazole, sodium pyrithione, and a combination thereof, and at least one second antimicrobial agent selected from the group consisting of tolyl diiodomethyl sulfone, tebuconazole, thiabendazole, 3-iodo-2-propynyl butylcarbamate, and a combination thereof.

20. The method of claim 18 wherein the at least one first bioactive cationic polymer latex, the at least one second bioactive cationic polymer latex, and the at least one third bioactive cationic polymer latex each is comprised of, independently:
a) a latex polymer comprising the polymerization product of:
i) at least one ethylenically unsaturated first monomer, and
ii) at least one ethylenically unsaturated second monomer that is cationic or a precursor to a cation;
b) at least one bioactive component at least partially encapsulated within the latex polymer; and
c) optionally, at least one sterically bulky component incorporated into the latex polymer.

21. The method of claim 20 wherein the at least one first bioactive cationic polymer latex, the at least one second bioactive cationic polymer latex, and the at least one third bioactive cationic polymer latex each further comprises, independently, a nonionic surfactant.

21. The method of claim 20 wherein the at least one first bioactive cationic polymer latex, the at least one second bioactive cationic polymer latex, and the at least one third bioactive cationic polymer latex, independently, is substantially devoid of cationic and anionic surfactants.

22. The method of claim 18 wherein the at least one ethylenically unsaturated first monomer is a vinyl aromatic monomer, a halogenated or a non-halogenated olefin monomer, an aliphatic conjugated diene monomer, a non-aromatic unsaturated mono- or dicarboxylic ester monomer, a monomer based on the half ester of an unsaturated dicarboxylic acid monomer, an unsaturated mono- or dicarboxylic acid monomer, a nitrile-containing monomer, a cyclic or an acyclic amine-containing monomer, a branched or an unbranched alkyl vinyl ester monomer, a halogenated or non-halogenated alkyl acrylate monomer, a halogenated or non-halogenated aryl acrylate monomer, a carboxylic acid vinyl ester, an acetic acid alkenyl ester, a carboxylic acid alkenyl ester, a vinyl halide, a vinylidene halide, or any combination thereof, any of which having up to 20 carbon atoms.

23. The method of claim 18 wherein the at least one ethylenically unsaturated first monomer is styrene, para-methyl styrene, chloromethyl styrene, vinyl toluene, ethylene, butadiene, methyl (meth)acrylate, ethyl (meth)acrylate, propyl (meth)acrylate, butyl (meth)acrylate, pentyl (meth)acrylate, glycidyl (meth)acrylate, isodecyl (meth)acrylate, lauryl (meth)acrylate, monomethyl maleate, itaconic acid, (meth)acrylonitrile, (meth)acrylamide, N-methylol (meth)acrylamide, N-(isobutoxymethyl)(meth)acrylamide, vinyl neodecanoate, vinyl versatates, vinyl acetate, a C₃-C₈ alkyl vinylether, a C₃-C₈ alkoxy vinylether, vinyl chloride, vinylidene chloride, vinyl fluoride, vinylidene fluoride, trifluoroethylene, tetrafluoroethylene, chlorotrifluoroethylene, hexafluoropropylene, chlorotrifluoroethylene, perfluorobutyl ethylene, a perfluorinated C₃-C₈ alpha-olefin, a fluorinated C₃-C₈ alkyl vinylether, a perfluorinated C₃-C₈ alkyl vinylether, a perfluorinated C₃-C₈ alkoxy vinyl ether, or any combination thereof.

24. The method of claim 18 wherein the at least one ethylenically unsaturated second monomer is an amine monomer, an amide monomer, a quaternary amine monomer, a phosphonium monomer, a sulfonium monomer, or any combination thereof, any of which having up to 20 carbon atoms.

25. The method of claim 18 wherein the at least one ethylenically unsaturated second monomer is dimethylaminoethyl acrylate; diethylaminoethyl acrylate; dimethyl aminoethyl methacrylate; diethylaminoethyl methacrylate; tertiary butylaminoethyl methacrylate; N,N-dimethyl acrylamide; N,N-dimethylaminopropyl acrylamide; acryloyl morpholine; N-isopropyl acrylamide; N,N-diethyl acrylamide; dimethyl aminoethyl vinyl ether; 2-methyl-1-vinyl imidazole; N,N-dimethylaminopropyl methacrylamide; vinyl pyridine; vinyl benzyl amine; dimethylaminoethyl acrylate, methyl chloride quaternary; dimethylaminoethyl methacrylate, methyl chloride quaternary; diallyldimethylammonium chloride; N,N-dimethylaminopropyl acrylamide, methyl chloride quaternary; trimethyl-(vinyloxyethyl)ammonium chloride; 1-vinyl-2,3-dimethylimidazolinium chloride; vinyl benzyl amine hydrochloride; vinyl pyridinium hydrochloride; or any combination thereof.

26. The method of claim 18 wherein the at least one sterically bulky component is at least one sterically bulky ethylenically unsaturated third monomer, at least one sterically bulky polymer, or any combination thereof.

27. The method of claim 18 wherein the at least one sterically bulky component is at least one a sterically bulky ethylenically unsaturated third monomer selected independently from:
a) CH₂═C(R^{1A})COO(CH₂CHR^{2A}O)ₘR^{3A}, wherein R^{1A}, R^{2A}, and R^{3A} are selected independently from H or an alkyl group having from 1 to 6 carbon atoms, inclusive, and m is an integer from 1 to 30, inclusive;
b) CH₂═C(R^{1B})COO(CH₂CH₂O)ₙ(CH₂CHR^{2B}O)ₚR^{3B}, wherein R^{1B}, R^{2B}, and R^{3B} are selected independently from H or an alkyl group having from 1 to 6 carbon atoms, inclusive, and n and p are integers selected independently from 1 to 15, inclusive;
c) CH₂═C(R^{1C})COO(CH₂CHR^{2C}O)_{q}(CH₂CH₂O)ᵣR^{3C}, wherein R^{1C}, R^{2C}, and R^{3C} are selected independently from H or an alkyl group having from 1 to 6 carbon atoms, inclusive, and q and r are integers selected independently from 1 to 15, inclusive; or
d) any combination thereof.

28. The method of claim 18 wherein the at least one sterically bulky component independently is an alkoxylated monoester of a dicarboxylic acid; an alkoxylated diester of a dicarboxylic acid; a polyoxyethylene alkylphenyl ether; a polymerizable surfactant; or any combination thereof.

29. The method of claim 18 wherein the at least one sterically bulky component is at least one sterically bulky polymer selected independently from polyvinyl alcohols, polyvinyl pyrollidone, hydroxyethyl cellulose, or any combination thereof.

30. The method of claim 18 wherein the at least one first bioactive cationic polymer latex, the at least one second bioactive cationic polymer latex, and the at least one third bioactive cationic polymer latex each is comprised of, independently, from about 20 percent to about 99.5 percent by weight of the ethylenically unsaturated first monomer, based on the total monomer weight.

31. The method of claim 18 wherein the at least one first bioactive cationic polymer latex, the at least one second bioactive cationic polymer latex, and the at least one third bioactive cationic polymer latex each is comprised of, independently, from about 0.01 percent to about 75 percent by weight of the ethylenically unsaturated second monomer, based on the total monomer weight.

32. The method of claim 18 wherein the at least one first bioactive cationic polymer latex, the at least one second bioactive cationic polymer latex, and the at least one third bioactive cationic polymer latex each is comprised of, independently, from about 0.01 percent to about 40 percent by weight bioactive additive, based on the total monomer weight.

33. The method of claim 18 wherein the at least one first bioactive cationic polymer latex, the at least one second bioactive cationic polymer latex, and the at least one third bioactive cationic polymer latex each is comprised of, independently, up to about 250,000 ppm by weight sterically bulky component, based on the total monomer weight.
